(19) United States
(12) Patent Application Publication
(10) Pub. No.: US 2009/0000475 A1
(43) Pub. Date: Jan. 1, 2009

(54) Zeolite membrane structures and methods of making zeolite membrane structures

(76) Inventors: Curtis Robert Fekety, Tioga, PA (US); Lyle David Kinney, Hammondsport, NY (US); Wei Liu, Painted Post, NY (US); Zhen Song, Painted Post, NY (US)

Correspondence Address: CORNING INCORPORATED, SP-TI-3-1, CORNING, NY, 14831, US

(21) Appl. No.: 11/824,464

(22) Filed: Jun. 29, 2007

(51) Int. Cl. B01D 53/047; B01J 20/02; B01J 20/28

(52) U.S. Cl. 95/105; 502/4

(57) ABSTRACT

Inorganic membrane structures of high stability, high permeability, and large surface area. Zeolite membranes can be disposed onto an intermediate pore size modification layer which reduces the pore size of the inorganic porous support. The intermediate pore size modification layer minimizes the defects in the zeolite membrane and provides a more continuous and uniform zeolite membrane. The inorganic membrane structure can be in the form of a honeycomb monolith. The applications for the zeolite membranes include, for example, membrane ultra-filtration of gas or liquid fluids, biological assays and cell culture surfaces.

### BACKGROUND

1. Field of the Invention

The present invention relates generally to zeolite membrane structures and more particularly to zeolite membrane structures useful for molecular-level separation and methods of making the same.

2. Technical Background

In the field of membrane separations, membrane materials deposited on porous supports are widely used for micro-filtration or ultra-filtration of liquid media and gas separation. The porous support functions to provide mechanical strength for the membrane materials.

Inorganic porous supports can be deposited with inorganic coatings to form a membrane structure for use in filtration and separation applications in the environmental, biological, food and drink, semiconductor, chemical, petrochemical, gas and energy industries. These industries often require purified gas/vapor or purified liquid whose source is a mixed feed stream composed of different gas and/or liquid/particulate combinations. Specific examples include purification and separation of hydrogen gas, sequestration of carbon dioxide gas, filtration of oil/water mixtures, wastewater treatment, filtration of wines and juices, filtration of bacteria and viruses from fluid streams, separation of ethanol from biomass, and production of high purity gas and water for the semiconductor and microelectronics industry.

Zeolite materials can be used as catalysts and adsorbents for reaction or separation processes, since zeolite materials offer a molecular-scale lattice channel to discriminate individual molecules based on a slight difference in weight, size and/or shape of the individual molecules. Furthermore, surface chemistry on a channel comprising a zeolite membrane can be adjusted to achieve specific molecular adsorption or reaction properties.

Zeolite membranes have long been sought by industry, since zeolite membranes and zeolite membrane reactors offer significant process efficiency advantages over conventional adsorption separation processes and catalytic reaction processes, respectively. Conventional zeolite membrane synthesis includes either a one-step growth method or, alternatively, a two-step growth method (or secondary growth method). In the conventional one-step method, zeolite crystals are grown directly on substrates. In the conventional secondary growth method, zeolite crystal seeds are first coated on the substrate and subsequent inter-crystal growth forms the zeolite membranes.

Zeolites typically are hydrothermally formed alumina silicates of Group I and Group II elements. They can be represented by the following empirical formula: M_{2/n}O.Al₂O₃.xSiO.2H₂O, wherein “x” is generally equal to or greater than two and “M” is a cation having a valency of “n”. Synthetic zeolites generally have a greater uniformity and purity than do natural zeolites, as well as a greater degree of reproducibility. As such synthetic zeolites are more reliably produced for industrial applications.

Synthetic zeolite membranes, including those grown on, or supported by, ceramic supports have many uses. For example, they exhibit catalytic properties, which give them considerable industrial importance. Also, the crystallographic structure of synthetic zeolites makes them particularly suitable for use as molecular sieves and cation exchangers for separation.

Fabrication of practical zeolite membranes, including supported zeolite membranes, has long been a goal of separation and catalyst science. Generally, zeolite membranes are formed by sequentially immersing a porous support in solutions of different reactants and then exposing the porous support, having the reactant solutions disposed in the pores of the porous support, to conditions sufficient to cause a zeolite to form, thereby forming a zeolite membrane.

However, sequentially immersing a porous support into various reactant solutions causes the distribution of reactions in the pores of the porous support to be irregular, resulting in zeolite membranes having significantly limited quality. For example, U.S. Pat. No. 4,800,187 discloses a method of crystallizing strong-bound zeolites on the surfaces of a ceramic porous support by hydrothermally treating the ceramic porous support in the presence of active silica, with a caustic bath to zeolitize the silica. As disclosed therein, the active silica can be present as a component of the caustic bath, in the form of a dried coating pre-deposited on the ceramic porous support, or as separate phase of the ceramic porous support, homogeneously dispersed within the ceramic material of the ceramic porous support.

For a zeolite membrane to be practical, it advantageously possesses high flux as well as selectivity. Obtaining such a zeolite membrane is challenging because of defects typically found in the zeolite membrane. Typically, membranes are grown using low alkaline synthesis routes as known in the art and involve the formation of several zones across the membrane thickness, involving the formation of larger crystals grown on top of smaller crystals. In several zones the crystals are not grown into a dense mat free of intercrystalline voids and therefore, in order to obtain a permselective zeolite membrane, the aforementioned zeolite layers comprised of these zones must be grown to an excessive thickness (>50 microns) to seal off voids and defects. This creates a great mass transfer resistance causing reduced flux. Obtaining functional zeolite membranes from high alkaline syntheses routes is difficult since the heterogeneous crystals in the zeolite membrane require an enormous membrane thickness to seal pinholes and void structures which lowers the membrane selectivity. The presence of such pinholes and voids can cause optical scattering in the synthesized high alkaline membrane.

WO 96/01686 describes a composition useful for separations of molecules and catalytic conversions which comprises a substrate, a zeolite or zeolite-like material in contact with the substrate and a selectivity enhancing coating in contact with the zeolite. This selectivity enhancing coating enhances the selectivity of the zeolite composition through a stabilization effect involving alleviating or dispersing mechanical stresses or deformations within the zeolite layer arising from harsh environments and a reparation effect involving the sealing of defects or voids in the zeolite layer.

U.S. Pat. No. 5,567,664 discloses membranes comprising crystalline zeo-type materials carried on a porous support, with the crystalline zeo-type material being essentially continuous over the pores of the porous support. The zeo-type crystalline material extends into, is crystallized directly from and bonds directly to the porous support. One difficulty arises in the complex method of forming this zeolite membrane. The complex method comprises immersing at least one surface of a porous support in a synthesis gel capable of crystallizing to produce a crystalline zeo-type material. The method thereafter involves inducing crystallization of the gel so that the zeo-type material crystallizes on the porous support. The method involves repeating these steps one or more, preferably 3-10, times to obtain a zeo-type material membrane which is crystallized directly from and bonds directly to the porous support.

The feasibility of molecular separation utilizing zeolite membranes has been researched. For example, high permeation flux and high selectivity for H₂/hydrocarbon separation over a MFI-type zeolite membrane is described by J. Dong, Y. S. Lin, and W. Liu in “Multicomponent hydrogen/hydrocarbon separation by MFI-type zeolite membranes” AIChE Journal 46, 1957 (2000).

However, conventional zeolite membranes are typically made in either disk or tubular form. The disk or tubular zeolite membrane structures possess low surface area packing density and impose large manufacturing and engineering costs on unit membrane separation area basis, which hinders widespread application of zeolite membranes.

Attempts have been made to make zeolite membranes on support structures of large surface area packing density such as monolithic ceramic supports. For example, a B-ZSM-5 zeolite membrane was prepared on a silicon carbide (SiC) monolithic substrate consisting of 60 of 2-mm-channels and exhibited a separation selectivity factor for n-butane to iso-butane of about 11 to 39 (Hail Kalipcilar, John L. Falconer, and Richard D. Noble, “Preparation of B-ZSM-5 membranes on a monolith support” Journal of Membrane Science 194 (2001) 141-144)).

The use of monolithic supports for zeolite membranes is described in commonly owned U.S. Pat. No. 6,440,885, the disclosure of which is incorporated by reference herein in its entirety.

Disadvantages of conventional membrane synthesis process include, for example, a long synthesis time, excessively large zeolite crystals, no preference of zeolite crystal growth on an internal surface of a channel or an internal surface of a tube, a limited number of nucleation sites on the substrate and therefore low volume density of zeolite crystals, difficulty in forming a zeolite membrane minimizing pinholes and excessively thick zeolite membranes.

It would be advantageous to provide a method of manufacturing zeolite membranes and membranes comprising zeolite utilizing an effective support structure in terms of chemical composition, geometries, and pore structures and utilizing an effective zeolite membrane structure in terms of pore structure variation along the membrane coating thickness on the support for separation applications.

### SUMMARY OF THE INVENTION

Inorganic membrane structures comprising a zeolite membrane and methods of making the same are described herein and address one or more of the above-mentioned disadvantages of the conventional zeolite membranes and/or the methods of making the conventional zeolite membranes.

Inorganic membrane structures of the present invention can be used for separation in processing industries with enhanced energy and capital efficiency, for example, CO₂ capture from flue gas streams for sequestration, H₂ recovery from waste gas streams, H₂ purification from a production gas mixture for fuel cells application and water removal from ethanol/water mixtures in biomass conversion processes.

In one embodiment, an inorganic membrane structure is disclosed. The inorganic membrane structure comprises an inorganic porous support comprising a first end, a second end, and a plurality of inner channels having surfaces defined by porous walls and extending through the support from the first end to the second end, one or more porous intermediate layers comprising inorganic particles coating the inner channel surfaces of the inorganic porous support, and a zeolite membrane comprising a zeolite seed layer coating the remaining surface of the one or more porous intermediate layers and a zeolite intergrown layer coating the zeolite seed layer.

In another embodiment, a method for making an inorganic membrane structure is disclosed. The method comprises providing an inorganic porous support comprising a first end, a second end, and a plurality of inner channels having surfaces defined by porous walls and extending through the support from the first end to the second end, applying one or more porous intermediate layers comprising inorganic particles to the inner channel surfaces of the inorganic porous support, applying a zeolite seed layer to the one or more porous intermediate layers, and hydrothermally growing a zeolite intergrown layer from the zeolite seed layer.

In another embodiment, a method of using the inorganic membrane structure for reducing the CO₂ content of a gas stream is disclosed. The method comprises introducing a feed gas comprising CO₂ into a first end of the inorganic membrane structure according to claim 1 and collecting a retentate gas stream lower in CO₂ content than the feed gas from a second end of the inorganic membrane structure.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawing figures.

FIG. 1 is a schematic of an inorganic membrane structure according to one embodiment.

FIG. 2 is a schematic of a cross-section of an inner channel of an inorganic membrane structure according to one embodiment.

FIG. 3 is a schematic of features of the sealing area used between a gas separation apparatus and an inorganic membrane structure according to one embodiment.

FIG. 4 is a scanning electron microscope (SEM) image of the crystal morphology of silicalite-1 seeds in the zeolite seed layer prepared by reflux method according to one embodiment.

FIG. 5 is a graph of the XRD phase pattern of the silicalite-1 seed shown in FIG. 4.

FIG. 6 is an SEM image of ZSM-5 zeolite seeds in the zeolite seed layer prepared with a reflux method according to one embodiment.

FIG. 7 is a graph of the XRD phase pattern of the ZSM-5 zeolite seeds shown in FIG. 6.

FIG. 8 is a graph of the particle size distribution of commercially available ZSM-5 (CBV-3020E) crystals before and after being ball-milled for 20 hours.

FIG. 9 is a graph of the XRD phase pattern of commercially available ZSM-5 zeolite crystals after being ball-milled for 20 hours and after being heated to 550° C.

FIG. 10A is a top down, SEM image of silicalite-1 seeds flow-coated on an inorganic porous support coated with multiple intermediate layers, wherein the top most intermediate layer has a median pore size of 200 nm.

FIG. 10B is a cross-sectional SEM image of the structure of FIG. 10A.

FIG. 11A is a top down SEM image of silicalite-1 seeds flow-coated on an inorganic porous support coated with multiple intermediate layers, wherein the top most intermediate layer has a median pore size of 800 nm.

FIG. 11B is a cross-sectional SEM image of the structure of FIG. 11A.

FIG. 12A shows a top down SEM image of features of an inorganic membrane structure according to one embodiment.

FIG. 12B shows a cross-sectional SEM image of features of an inorganic membrane structure according to one embodiment.

FIG. 13A shows a top down SEM image of features of an inorganic membrane structure according to one embodiment.

FIG. 13B shows a cross-sectional SEM image of features of an inorganic membrane structure according to one embodiment.

FIG. 14 is a graph of the CO₂ content at the permeate and retentate sides of a silicalite-1 monolith membrane vs. feed pressure according to one embodiment.

FIG. 15 is a graph of the separation factor for CO₂ over He for the He/CO₂ gas mixture vs. feed pressure by the silicalite-1 monolith membrane according to one embodiment.

FIG. 16 is a graph of the CO₂ permselectivity and permeance flux of the silicalite-1 membrane vs. the feed pressure for a He/CO₂ gas mixture.

### DETAILED DESCRIPTION

Reference will now be made in detail to various embodiments of the invention, examples of which are illustrated in the accompanying drawings. Wherever possible, the same reference numbers will be used throughout the drawings to refer to the same or like parts.

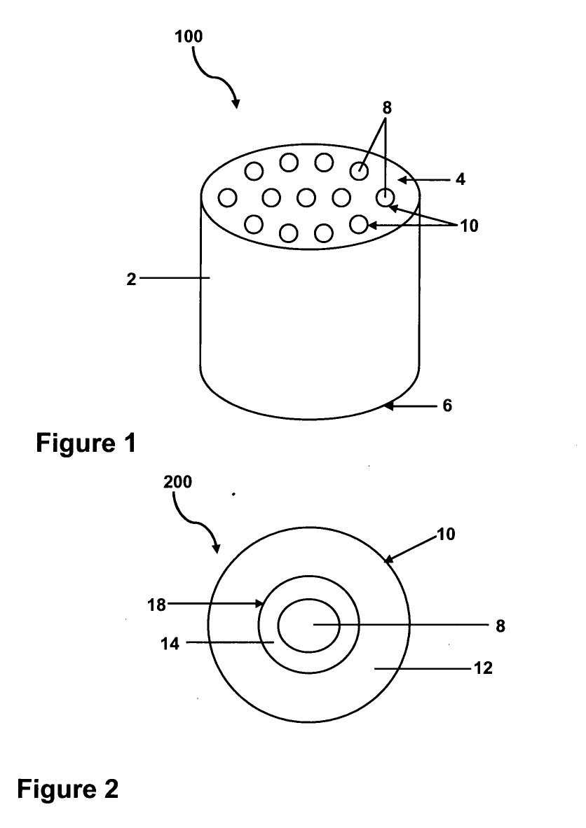

An inorganic membrane structure 100 in FIG. 1 and features 200 of the inorganic membrane structure as shown in FIG. 2 are disclosed. The inorganic membrane structure comprises an inorganic porous support 2 comprising a first end 4, a second end 6, and a plurality of inner channels 8 having surfaces 10 defined by porous walls and extending through the support 2 from the first end 4 to the second end 6; one or more porous intermediate layers 12 comprising inorganic particles coating the inner channel surfaces 10 of the inorganic porous support, and a zeolite membrane 14 comprising a zeolite seed layer coating the remaining surface 18 of the one or more porous intermediate layers 12 and a zeolite intergrown layer coating the zeolite seed layer.

According to one embodiment, the inorganic porous support comprises alumina, cordierite, alpha-alumina, mullite, aluminum titanate, titania, zirconia, zeolite, metal, stainless steel, silica carbide, ceria or combinations thereof.

In one embodiment, the inorganic porous support is in the form of a honeycomb monolith. The honeycomb monolith can be manufactured, for example, by extruding a mixed batch material through a die and utilizing methods known in the art.

According to one embodiment, the inner channels of the inorganic porous support have a median inside diameter of from 0.5 millimeters to 3 millimeters, for example, 0.5 millimeters to 1.5 millimeters. According to other embodiments, the inner channels of the inorganic porous support have a median inside diameter of from 0.8 millimeters to 1.5 millimeters.

The porous walls of the inorganic porous support, according to one embodiment, comprise a median pore size of from 1 micron to 25 microns, for example, a median pore size of from 5 microns to 15 microns.

Further, according to some embodiments, the inorganic porous support has a porosity of from 20 percent to 80 percent, for example, a porosity of from 30 percent to 60 percent and in some embodiments, a porosity of from 40 percent to 50 percent. When a metal, for example, a stainless steel is used as the porous support. The porosity in the inorganic support can be realized, for example, through engineered pores or channels made by three dimensional printing or high energy particle tunneling or by particle partial sintering with a pore former used to adjust the porosity and pore size.

The one or more porous intermediate layers provide a smooth surface on the porous walls of the inner channels of the inorganic porous support. The one or more porous intermediate layers have a combined thickness, for example, from 1 micron to 100 microns in thickness.

Inorganic porous supports and coated inorganic porous supports as described in commonly owned U.S. Provisional Patent Applications 60/932,469, 60/903,637, 60/874,070 and U.S. patent application Ser. No. 11/729,732, the disclosures of which are incorporated herein by reference in their entirety, describe inorganic porous supports and coated inorganic porous supports which can be coated with the one or more intermediate layers and the zeolite membranes or by the zeolite membranes described by the present invention.

In one embodiment, the one or more porous intermediate layers comprise alpha-alumina, cordierite, alumina, mullite, aluminum titanate, titania, zirconia, ceria particles or combinations thereof.

The one or more porous intermediate layers, according to one embodiment, comprise a median pore size of from 1 micron to 10 microns, for example, a median pore size of from 50 nanometers to 1 micron.

In one embodiment, the median pore size of the porous walls of the inorganic porous support is larger than the median pore size of each of the one or more porous intermediate layers, and the median pore size of each of the one or more porous intermediate layers is larger than the crystal channel size of the zeolite membrane. In another embodiment, when the inorganic membrane structure comprises two or more porous intermediate layers, the median pore size of the intermediate layer which contacts the inorganic porous support is greater than the median pore size of the intermediate layer which contacts the zeolite seed layer.

This inorganic porous support and porous intermediate layer(s) structure provides high permeability from the inner channels, through the larger pores of the intermediate layer(s) and through the still larger pores of the inorganic porous support to the outside of the inorganic porous support. The smooth inner channel surfaces enable a thin zeolite membrane to form the gas separation membrane, which gives high permeance to the gas being separated.

The zeolite membrane comprises a zeolite seed layer and an intergrown zeolite layer. According to one embodiment, the zeolite seed layer of the zeolite membrane comprises seed particles having median particle sizes of from 50 nanometers to 500 nanometers, for example, from 50 nanometers to 150 nanometers.

According to another embodiment, a method for making an inorganic membrane structure is described. The method comprises providing an inorganic porous support comprising a first end, a second end, and a plurality of inner channels having surfaces defined by porous walls and extending through the support from the first end to the second end, applying one or more porous intermediate layers comprising inorganic particles to the inner channel surfaces of the inorganic porous support, applying a zeolite seed layer to the one or more porous intermediate layers, and hydrothermally growing a zeolite intergrown layer from the zeolite seed layer.

According to one embodiment, the porous inorganic support is coated with one intermediate layer comprising inorganic particles comprising alpha-alumina, cordierite, alumina, mullite, aluminum titanate, titania, zirconia, ceria particles or combinations thereof. The inorganic porous support coated with the one intermediate layer is then dried and subsequently fired to sinter the inorganic particles of the one intermediate layer. Multiple intermediate layers can be applied to the coated inorganic porous support with drying and firing occurring after each coating of an intermediate layer.

The drying and firing schedules can be adjusted based on the materials used in the inorganic porous support and the intermediate layers. For example, an alpha-alumina intermediate layer applied to an alpha-alumina inorganic porous support could be dried in a humidity and oxygen controlled environment holding at a maximum temperature of 120° C. for 5 hours and subsequently fired at a temperature of from 900° C. to 1200° C. under a controlled gas environment. Firing removes organic components and sinters the inorganic particles in the intermediate layer.

After drying and firing, the inorganic porous support comprising one or more intermediate layers is coated with a zeolite seed layer to cover the inner channel surfaces. After coating with the zeolite seed layer, the inorganic porous support coated with the intermediate layer(s) and coated with the zeolite seed layer is dried and subsequently fired. The drying and firing schedules can be adjusted based on the specific zeolite material used in the zeolite seed layer. For example, silicalite-1 and ZSM-5 zeolite materials can be dried as described above and fired at a temperature of from 400° C. to 700° C. under a controlled gas environment, for example at a temperature of from 450° C. to 550° C., for example, 500° C.

Zeolite seed particles can be synthesized utilizing a mild chemical process, for example, a hydrothermal process, which is followed by filtering and centrifuge separation. Alternatively, zeolite seed particles can also be prepared by grinding or ball-milling commercially available zeolite powder having large particle sizes into smaller particles sizes.

The zeolite seed layer application can be performed by various coating processes, for example, dip-coating, flow-coating, slip casting, immersion or combinations thereof. Flow-coating, for example, as described in commonly owned U.S. patent application Ser. No. 11/729,732, the disclosure of which is incorporated by reference in its entirety, can be used to uniformly coat the zeolite seed particles onto the surfaces of the inner channels of the coated inorganic porous support. The slips used in the flow-coating process have zeolite seed particles dispersed in water at a concentration of from 0.1 weight percent (wt %) to 2 wt %, which can result in a continuous zeolite seed layer having a thickness of from 0.5 microns to 5 microns. The coating comprising zeolite seeds can be applied from a coating composition that further comprises a dispersant, a binder, an anti-cracking agent, an anti-foam agent or combinations thereof.

According to one embodiment, the method further comprises applying seal material to the distal ends of the outer surfaces of the inorganic porous support coated with the one or more intermediate layers prior to applying the zeolite seed layer. The seal material is applied, for example by spraying, painting, dip-coating or combinations thereof. The seal material functions as a seal between the inorganic membrane structure and the apparatus used for the gas separation process. The length of the seal can be adjusted based on the size of the locking mechanism of the separation apparatus and can be, for example from 0.5 centimeters to 1.5 centimeters. The seal material can be chosen based on the material's ability to remain non-porous at high temperature gas separation applications, for example, temperatures of from 300° C. to 600° C. It is advantageous that the seal material is impermeable to the feed gas in the separation process. The seal material can comprise for example, a glass or a glass glaze, for example, commercially available Duncan Glaze.

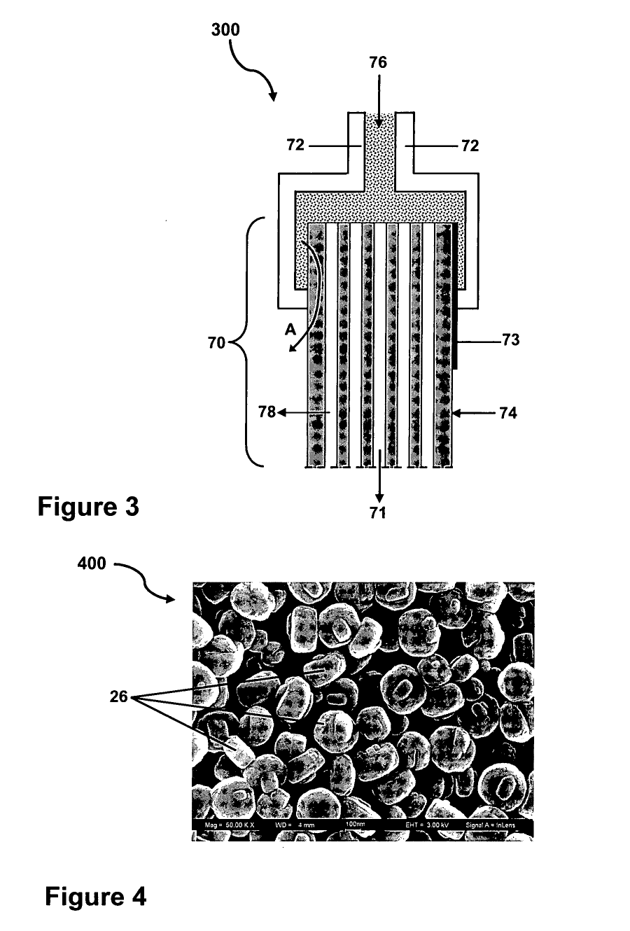

FIG. 3 shows features 300 of the connection of inorganic membrane structure 70 with the separation apparatus (not shown). The sealing mechanism 72 of the separation apparatus are pressed onto the outer surface 74 of the inorganic membrane structure. Since the outer surface of the inorganic membrane structure is porous, if the ends of the outer surface of the inorganic porous support are not sealed, feed gas 76 can bypass the inorganic membrane structure through the porous walls of the support to the permeate side 78 of the inorganic membrane structure. If the ends of the outer surfaces of the inorganic porous support are sealed with the seal 73, the feed gas 76 permeates to the permeate side only through the inorganic membrane structure, as shown by arrow A. The remaining feed gas can exit the inorganic membrane structure through the retentate side 71.

However, the glass glaze can be etched out in the pH basic zeolite synthesis solution. A barrier layer, as described below, can be applied to the seal to protect the seal material from being etched. For example, shrink tubing, available through McMaster-Carr, can keep the seal material intact after the zeolite, for example, silicalite-1 and ZSM-5 synthesis.

The zeolite seed layer coated support is then immersed in the zeolite synthesis solution. An intergrown zeolite layer is then hydrothermally grown from the zeolite seed layer. The hydrothermally growth of the zeolite intergrown layer from the zeolite seed layer can be assisted by microwave energy, for example as later described in Example 3. The intergrown zeolite layer reduces the presence of voids and/or gaps in the seeding layer. This secondary growth of zeolite crystals is followed with drying and subsequently firing.

According to some embodiments, the support coated with the intergrown zeolite layer is rinsed with deionized water for 2 hours and immersed in deionized water for 24 hours prior to drying.

In some embodiments, drying is performed at room temperature under ambient conditions for 10 hours to 48 hours, for example, 20 hours to 28 hours. According to some embodiments, firing is performed at firing temperatures of from 300° C. to 700° C., for example at a temperature of from 450° C. to 550° C., for example, 500° C. for 10 hours. The ramp rate, according to one embodiment, is 30° C./hour. According to one embodiment, the cool down rate is, for example, 30° C./hour.

In the secondary growth, either a microwave assisted hydrothermal method or an autoclave hydrothermal method can be used. The concentration of basic material (by pH measurement) should be low to prevent zeolite crystal growth in the synthesis solution or inside the pores of the inorganic porous support. The molar ratio of H₂O and OH⁻ in the synthesis solution can range from 200 to 700.

During the secondary zeolite growth, the inorganic porous support coated with one or more intermediate layers is placed in the autoclave with the inner channels oriented in a vertical direction such that any gas bubbles generated during the secondary zeolite growth may easily float out of the inner channels in order to minimize reaction sites on the surfaces of the inner channels from being blocked by the gas bubbles.

It is advantageous to block the pores and the inorganic material of the outer surface of the inorganic porous support prior to the secondary zeolite growth. According to one embodiment, a barrier layer is applied to the outer surface of the inorganic porous support, for example by spraying, wrapping, coating or combinations thereof. Any material capable of withstanding the secondary growth process can be used as the barrier layer, for example, a wrap or a coating comprising a material, for example, a metal, a polymer coating, a polymer wrap, Teflon®, a plastic wrap, syran wrap, aluminum foil, shrink wrap tubing, epoxy, a glass, a ceramic, a glass/ceramic, a rubber, a latex and the like, and combinations thereof. Blocking the outer surface of the inorganic porous support minimizes the secondary zeolite growth on the outer surface and inside the pores of the outer surface of the inorganic porous support.

For uniform growth of the zeolite membrane, the synthesis (growth) solution should be stirred or circulated to keep uniform concentration from top to bottom and around the inorganic porous support.

### EXAMPLE 1

### Preparation of Silicalite-1 and ZSM-5 Seed Layer Particles

Silicalite and ZSM-5 are MFI type zeolites. In this example, silicalite-1 and ZSM-5 seed particles are grown utilizing a reflux method.

In the silicalite-1 seed synthesis, a synthesis solution was prepared with tetraethylorthosilicate (TEOS, 98%, Alfa Aesar), tetrapropylammonium (TPAOH, 40%, Alfa Aesar), pure H₂O and NaOH. The molar ratio of TEOS/TPAOH/H₂O/NaOH was 1/0.15/18.8/0.008. The synthesis solution was prepared at room temperature. In this preparation, H₂O and NaOH were first mixed together and then, TPAOH was added while stirring at room temperature. TEOS was then added drop-wise while stirring. The synthesis solution was continuously stirred for 24 hours. The final synthesis solution was clear in color.

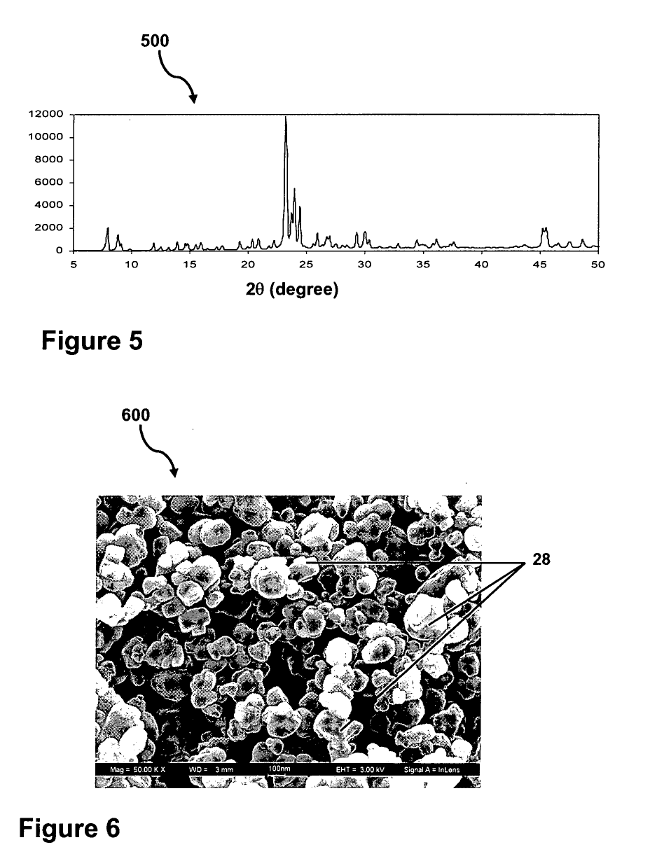

The reflux seed synthesis was conducted at 85° C. for 72 hours. The final synthesis solution was filtered with No. 40 filter paper to remove large particles having diameters greater than 1 micron. The filtered synthesis solution was then separated using a Biofuge 17 centrifuge at 9500 rpm for 10 minutes. FIG. 4 is a top down SEM image of features 400 of the resulting silicalite-1 seed particles 26. The crystal size is about 100 by about 200 nanometers. As shown by the XRD plot 500 in FIG. 5, the silicalite-1 seed particles produced by the reflux method as described above have phase patterns similar to standard silicalite-1 patterns.

In the ZSM-5 seed synthesis, the synthesis solution was prepared at room temperature with TPAOH (40%), SiO₂ (40% sol, Ludox-As-40), H₂O, NaOH and Al (foil) at molar ratios of 1/6/300/3/0.06. Al foil was first dissolved in NaOH (40%) solution. Water and TPAOH was then added while stirring. SiO₂ sol was added drop-wise and the synthesis solution was continuously stirred for 24 hours. The final synthesis solution was opaque in color.

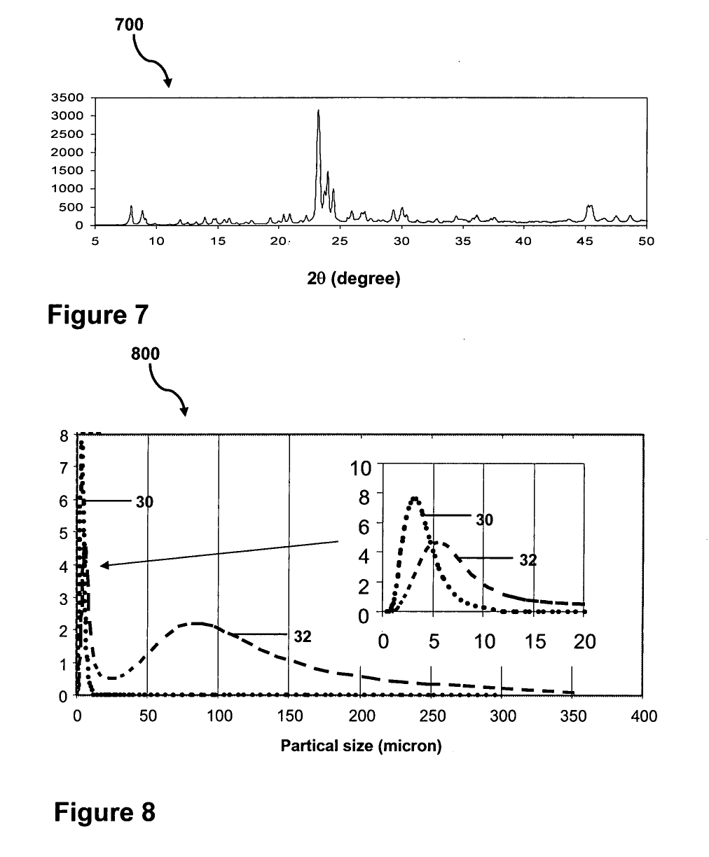

The zeolite seed synthesis was conducted at 100° C. for 72 hours. FIG. 6 is a top down SEM image of features 600 of the zeolite seed particles 28. The zeolite seed particle size is from 50 to 100 nanometers. As shown by the XRD plot 700 in FIG. 7, the XRD phase pattern of the zeolite seed particles prepared by the method described above are similar to standard ZSM-5 phase patterns.

Another method for preparing the zeolite seed particles is to grind or to ball-mill commercially available zeolite crystals which typically have large agglomerates of particles into smaller particle sizes. The plot 800 in FIG. 8 shows the CBV 3020E ZSM-5 (Zeolyst) particle size distribution 30 after ball-milling the commercially available zeolite crystals for 20 hours as compared to the particle size distribution 32 of the commercially available zeolite crystals as purchased. The large agglomerates of around 80 μm found in the commercially available zeolite prior to ball-milling are not found in the zeolite after ball-milling. The median particle size of the zeolite after ball-milling is 3 μm.

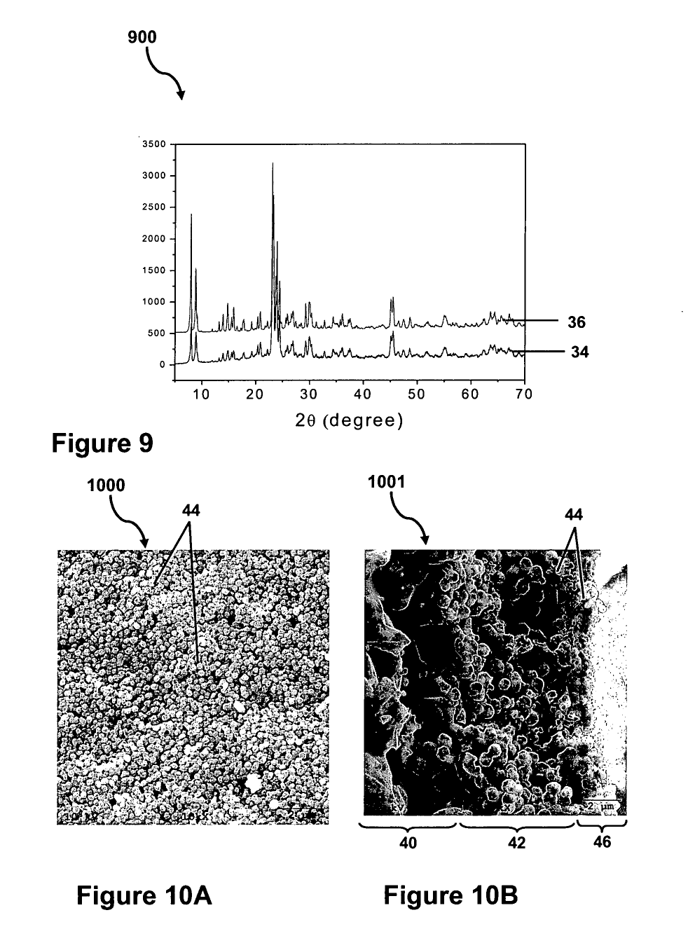

For zeolite/membrane preparation, zeolite seed particles having small diameters, for example, from 50 to 150 nanometers is advantageous for producing a uniform and thin coating of the zeolite seed particles on the inorganic porous support. The smaller the zeolite seed particles, the smaller the pore size in the resulting zeolite membrane. Smaller zeolite seed particles are advantageous for producing pin-hole free inter-crystal growth in the zeolite membrane. The thermal stability of the ball-milled ZSM-5 crystals was measured by XRD. The plot 900 in FIG. 9 shows the XRD phase patterns from the ball-milled ZSM-5 34 and this sample being heated to 550° C. 36. No obvious change in the crystal structure was observed.

### EXAMPLE 2

### Coating of Zeolite Seeding Crystals on Alpha-Alumina Inorganic Porous Supports

In this example, the silicalite-1 seeds similar to those shown in FIG. 4 were flow-coated onto two pure α-Al₂O₃ honeycomb monolith inorganic porous supports with two different pore sizes on the top intermediate layer; one having a median pore size of about 200 nm, the other having a median pore size of about 800 nm. The honeycomb monolith inorganic porous supports had an outer diameter of about 9.7 mm with 19, 0.8 mm rounded inner channels uniformly distributed over the cross-sectional area of the honeycomb monolith inorganic porous supports. The honeycomb monolith inorganic porous supports were made of alpha-alumina with a median pore size of about 10 μm and a median porosity of about 45%. The inner channel surfaces of the honeycomb monolith inorganic porous supports were modified with intermediate layers of alpha-alumina material.

The zeolite seed layer coating slips were the same for both honeycomb monolith inorganic porous supports described above, comprising 0.5% silicalite-1 seed dispersed in pure H₂O. The pH values of the slips were 8.4. The zeolite seeds were flow-coated onto the inner channel surfaces of the honeycomb support. In this flow-coating process, the honeycomb support was wrapped with a Teflon® tape for a gas seal. The coating slips were introduced into the inner channels of the honeycomb support by applying a vacuum. The soaking time for the honeycomb support in the coating slip solution was controlled at 10 sec, and the coating slip solution was allowed to flow out of the honey comb support. After the zeolite seed layer coating, the excessive solution was removed by spinning honeycomb monolith inorganic porous supports coated with the zeolite seed layer. The resulting honeycomb monolith inorganic porous supports comprising inner channel surfaces coated with the zeolite seed layer were dried at 120° C. in 90% humidity for 10 hours, and then, calcined at 500° C. for 12 hours at heating rate of 60°/hr.

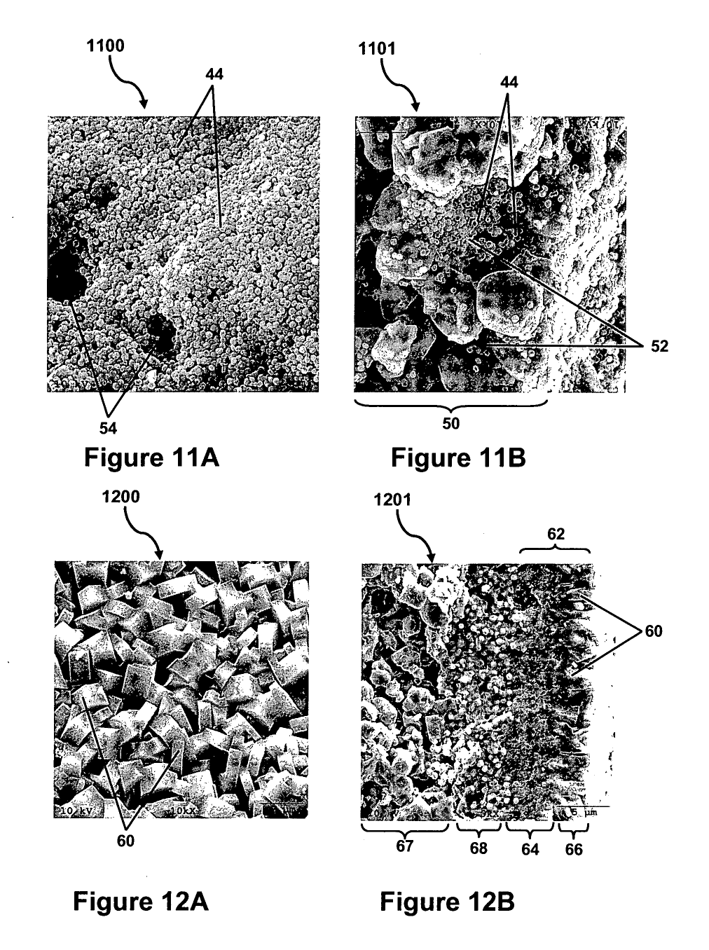

The resulting zeolite seed layer morphologies are shown in the SEM images in FIG. 10A, FIG. 10B, FIG. 11A and FIG. 11B. Features 1000 and 1001 of the resulting zeolite seed layer are shown in the top down image in FIG. 10A and in the cross sectional image in FIG. 10B respectively. An the intermediate layer 42 having a median pore size of 200 nm reduces the median pore size of the intermediate layer 40 and the 200 nm silicalite-1 seeds 44 form a uniform zeolite seed layer 46 with a median thickness of 1 μm. The zeolite seed particles have either insignificant or no penetration into the intermediate layer(s).

Features 1100 and 1101 of the resulting zeolite seed layer are shown in the top down image in FIG. 11A and in the cross sectional image in FIG. 11B respectively. On the intermediate layer 50 having a median pore size of 800 nm, the 200 nm silicalite-1 seeds 44 penetrate into the intermediate layer 50. Defects 54 are present in the zeolite seed layer. Penetration of the zeolite seed particles can induce growth of zeolite crystals during the hydrothermal growth process inside the pores of the support, and thus, decrease the permeability of the inorganic membrane structure in the separation process.

### EXAMPLE 3

### Preparation of Intergrown, Dense Silicalite-1 Layer with a Microwave Assisted Hydrothermal Reaction Method

The silicalite-1 seed coated support samples were processed by a secondary growth with a microwave assisted hydrothermal reaction method for intergrowth of the zeolite seed layer to form a dense silicalite-1 membrane. The synthesis solution for the secondary growth was prepared with the same material as used for the seed growth described in Example 1, but with a molar ratio of TEOS/TPAOH/H₂O=1/0.12/5.8. The microwave assisted secondary growths were carried out using a Milestone 1600 microwave reactor with a 100 ml Teflon® autoclave.

2½ inch long honeycomb monolith inorganic porous supports with inner channel surfaces modified with intermediate layers of alpha-alumina material, coated with the silicalite-1 seed layer, dried and fired were vertically put into the Teflon® autoclave and immersed in the synthesis solution. The reaction condition was set at 400 Watts microwave power, 150° C. for 90 minutes. This heating power allowed the solution temperature to reach to 150° C. from RT within 10 minutes. During the hydrothermal reaction, the pressure was measured at 5 bar. After the secondary growth, microwave assisted hydrothermal reaction, the inorganic membrane structure were cooled down naturally.

FIG. 12A shows a top down SEM image of features 1200 of the intergrown zeolite layer according to one embodiment. The intergrown zeolite layer comprises intergrown silicalite crystals 60, which are columnar in shape. The silicalite membrane was prepared by a secondary growth with a microwave assisted hydrothermal growth method.

FIG. 12B shows a cross-sectional SEM image of features 1201 of an inorganic membrane structure according to one embodiment. The silicalite membrane 62 comprises a silicalite seed layer 64 coating the one or more porous intermediate layers 67 and 68 and a silicalite intergrown layer 66 coating the silicalite seed layer.

The intergrown zeolite was prepared with a 0.5% seed slip flow-coating process which was followed by a secondary growth with a microwave assisted hydrothermal growth method. The median thickness of the silicalite membrane is 7 μm. According to another embodiment, a 1% seed slip flow-coating process which was followed by a secondary growth with a microwave assisted hydrothermal growth method resulted in a silicalite membrane thickness of 10 μm. The silicalite seed particles in the silicalite seed layer have been inter-grown during the secondary growth. The thickness of the zeolite membranes was measured and averaged with inner channels across two diameters of the inorganic membrane structure at several positions along the length of the inner channels.

### EXAMPLE 4

### Preparation of Inter-Grown, Dense ZSM-5 Layer with a Hydrothermal Reaction Method

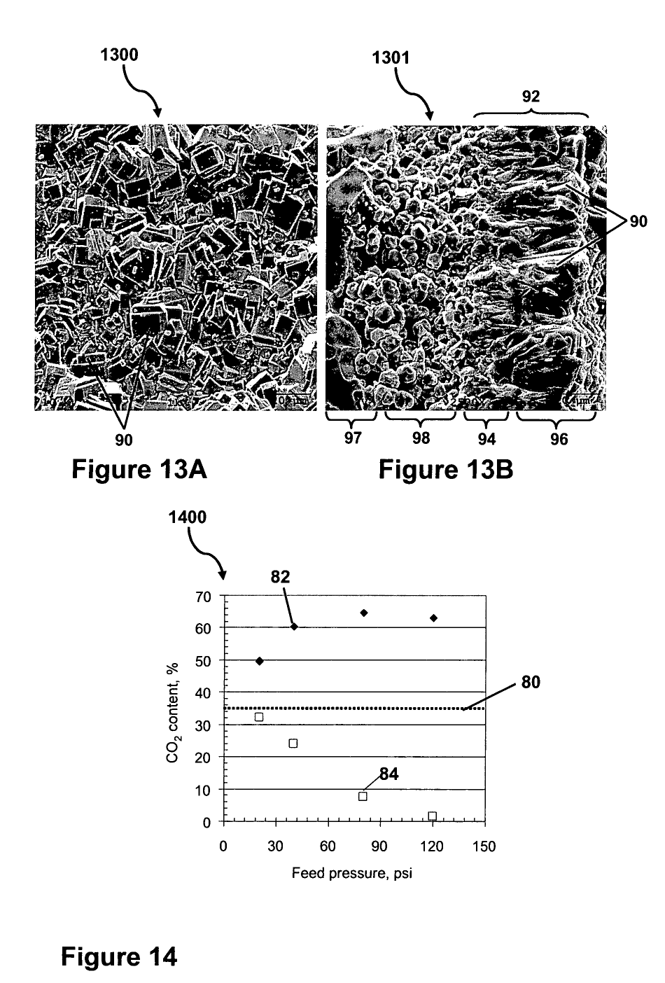

ZSM-5 seed coated monoliths were processed by a secondary growth method using a conventional hydrothermal reaction. The synthesis solution contained TPABr/TEOS/H₂O/NaOH/Al with the molar ratio of 1/6/583/2/0.04. The hydrothermal reaction was performed in a Parr acid digestion vessel at 170° C. for 24 hours. FIG. 13A shows a top down SEM image of features 1300 of an inorganic membrane structure according to one embodiment. FIG. 13B shows a cross-sectional SEM image of features 1301 of an inorganic membrane structure, according to one embodiment. The ZSM-5 membrane 92 comprises a ZSM-5 seed layer 94 coating the one or more porous intermediate layers 97 and 98 and a ZSM-5 intergrown layer 96 coating the ZSM-5 seed layer.

At the root of the ZSM-5 membrane, the ZSM-5 crystals are very well inter-grown. The median thickness of the ZSM-5 membrane is 10 μm.

### EXAMPLE 5

### Prevention of the Growth at the External Surface

In the secondary growth, it can be valuable to prevent the zeolite growth on the outer surface of the honeycomb monolith inorganic porous support and also inside the pores of the honeycomb monolith inorganic porous support by applying a barrier layer to the outer surface of the support. Undesirable zeolite crystal growth on the outer surface and on the inside the pores of the outer porous walls of the support can be avoided by minimizing the penetration of the synthesis solution into the support and also by minimizing the exposure of the outer surface to the support to the synthesis solution through the application of the barrier layer.

In this example, the outer surface of one honeycomb inorganic porous support was wrapped with a Teflon® tape or a shrink tube material.

The experimental conditions were the same as described in Example 3. In this comparative test, the outer surface of one honeycomb monolith inorganic porous support was wrapped after the application of the zeolite seed layer, while the outer surface of a second honeycomb monolith inorganic porous support was not wrapped after the application of the zeolite seed layer. After the secondary growth process, the wrapped support showed a minimal amount of zeolite crystal growth on the outer surface of the support such that the gas permeation during the separation process would not be hindered. By contrast, a dense layer of zeolite was grown on the outer surface of the unwrapped support and the dense zeolite layer penetrated deep into the unwrapped support at a depth of greater than 200 μm which could significantly hinder the gas permeation during the separation process.

The barrier layer, for example, the shrink tube wrapping, is also advantageous for protecting the end seals, for example, glass glaze, from been etched by the pH basic synthesis solution.

### EXAMPLE 6

### The Monolith Silicalite-1 Membrane Separation Test He/CO₂

In another embodiment, a method of using the inorganic membrane structure for reducing the CO₂ content of a gas stream is disclosed. The method comprises introducing a feed gas comprising CO₂ into a first end of the inorganic membrane structure according to claim 1 and collecting a retentate gas stream lower in CO₂ content than the feed gas from a second end of the inorganic membrane structure.

In this embodiment, it is believed that CO₂ selectively permeates through the zeolite membrane and exits through the outer surface of the inorganic membrane structure, while the remaining gas mixture exits through the second end of the inorganic membrane structure. The method can be advantageously used, for example, in separating CO₂ and H₂ gases.

A He/CO₂ gas mixture separation test was used to simulate the H₂/CO₂ separation functionality of the silicalite-1 monolith zelolite membrane. In this example, the feed gas was a mixture of He and CO₂ having concentrations of 65% and 35% of the total feed gas mixture, respectively. When the gas mixture passed through the membrane, the CO₂ was preferentially adsorbed on the silicalite-1 membrane. This adsorption blocked the He from passing through the silicalite-1 membrane. The adsorbed CO₂ was diffused into the bulk of the silicalite-1 membrane through the lattice of the inner channels to the other side of the silicalite-1 membrane and then desorbed. Therefore, the silicalite-1 membrane had a higher selectivity for CO₂ over He.

In this example, the feed pressure was changed from 20 to 120 psi. The permeate side was kept at ambient pressure. The measured CO₂ content in the permeate and retentate sides of the membrane vs. the feed gas pressure is shown by the graph 1400 in FIG. 14, in which the guild line 80 indicates the feed gas CO₂ content.

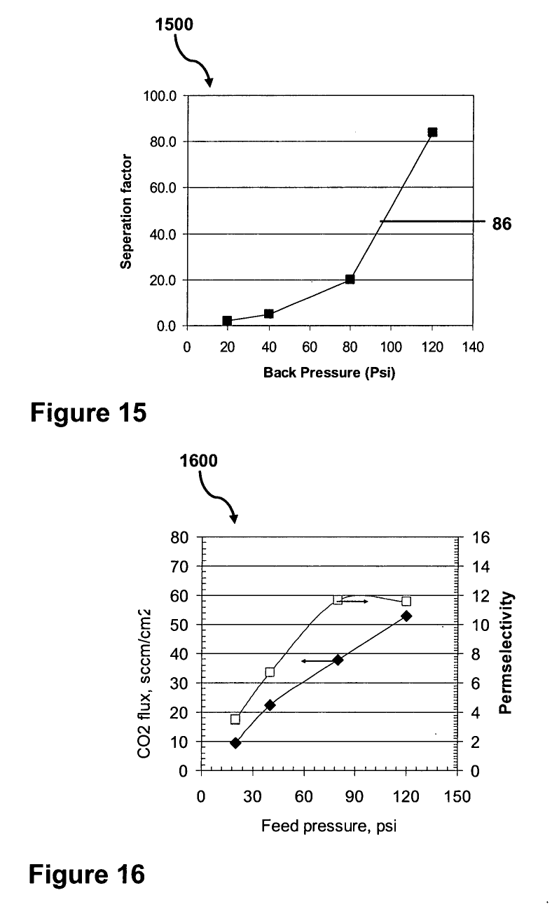

The separation factor for CO₂ over He for the He/CO₂ gas mixture vs. feed pressure by the silicalite-1 monolith membrane, according to one embodiment, is shown by the graph 1500 in FIG. 15. In FIG. 15, the separation factor is based on the ratio of permeate 82 and retentate 84 (as shown in FIG. 14) gas concentration as shown by the plot 86 in FIG. 15, and increases with the feed pressure.

The permselectivity of the silicalite-1 membrane and the permeance flux are shown in the graph 1600 in FIG. 16. The data shows a good separation performance (high separation factor at high permeate flux) of the monolith silicalite-1 membrane.

What is claimed is:

1. An inorganic membrane structure comprising:
an inorganic porous support comprising a first end, a second end, and a plurality of inner channels having surfaces defined by porous walls and extending through the support from the first end to the second end;
one or more porous intermediate layers comprising inorganic particles coating the inner channel surfaces of the inorganic porous support; and
a zeolite membrane comprising a zeolite seed layer coating the remaining surface of the one or more porous intermediate layers and a zeolite intergrown layer coating the zeolite seed layer.

2. The inorganic membrane structure according to claim 1, wherein the inorganic porous support is in the form of a honeycomb monolith.

3. The inorganic membrane structure according to claim 1, wherein the inorganic porous support comprises alumina, cordierite, alpha-alumina, mullite, aluminum titanate, titania, zirconia, zeolite, metal, stainless steel, silica carbide, ceria or combinations thereof.

4. The inorganic membrane structure according to claim 1, wherein the inner channels of the inorganic porous support have a median inside diameter of from 0.5 millimeters to 3 millimeters.

5. The inorganic membrane structure according to claim 1, wherein the porous walls of the inorganic porous support comprise a median pore size of from 1 micron to 25 microns.

6. The inorganic membrane structure according to claim 5, wherein the porous walls of the inorganic porous support comprise a median pore size of from 5 microns to 15 microns.

7. The inorganic membrane structure according to claim 1, wherein the inorganic porous support has a porosity of from 20 percent to 80 percent.

8. The inorganic membrane structure according to claim 7, wherein the inorganic porous support has a porosity of from 30 percent to 60 percent.

9. The inorganic membrane structure according to claim 8, wherein the inorganic porous support has a porosity of from 40 percent to 50 percent.

10. The inorganic membrane structure according to claim 1, wherein the one or more porous intermediate layers comprise alpha-alumina, cordierite, alumina, mullite, aluminum titanate, titania, zirconia, ceria particles or combinations thereof.

11. The inorganic membrane structure according to claim 1, wherein the one or more porous intermediate layers comprise a median pore size of from 1 micron to 10 microns.

12. The inorganic membrane structure according to claim 1, wherein the one or more porous intermediate layers comprise a median pore size of from 50 nanometers to 1 micron.

13. The inorganic membrane structure according to claim 1, wherein the one or more porous intermediate layers have a combined thickness of from 1 micron to 100 microns.

14. The inorganic membrane structure according to claim 1, wherein the median pore size of the porous walls of the inorganic porous support is larger than the median pore size of each of the one or more porous intermediate layers, and the median pore size of each of the one or more porous intermediate layers is larger than the crystal channel size of the zeolite membrane.

15. The inorganic membrane structure according to claim 14, which comprises two or more porous intermediate layers, wherein the median pore size of the intermediate layer which contacts the inorganic porous support is greater than the median pore size of the intermediate layer which contacts the zeolite seed layer.

16. The inorganic membrane structure according to claim 1, wherein the zeolite seed layer comprises seed particles having a median particle size of from 50 nanometers to 500 nanometers.

17. The inorganic membrane structure according to claim 16, wherein the zeolite seed layer comprises seed particles having median particle sizes of from 50 nanometers to 150 nanometers.

18. A method for reducing the CO₂ content of a gas stream, which comprises introducing a feed gas comprising CO₂ into a first end of the inorganic membrane structure according to claim 1 and collecting a retentate gas stream lower in CO₂ content than the feed gas from a second end of the inorganic membrane structure.

19. A method for making an inorganic membrane structure, the method comprising:
providing an inorganic porous support comprising a first end, a second end, and a plurality of inner channels having surfaces defined by porous walls and extending through the support from the first end to the second end;
applying one or more porous intermediate layers comprising inorganic particles to the inner channel surfaces of the inorganic porous support;
applying a zeolite seed layer to the one or more porous intermediate layers; and
hydrothermally growing a zeolite intergrown layer from the zeolite seed layer.

20. The method according to claim 19, further comprising applying a barrier layer to the outer surface of the inorganic porous support prior to hydrothermally growing the zeolite intergrown layer from the zeolite seed layer.

21. The method according to claim 20, wherein the barrier layer comprises a material selected from a metal, a polymer coating, a polymer wrap, Teflon®, a plastic wrap, syran wrap, aluminum foil, a shrink wrap tubing, an epoxy, a glass, a ceramic, a glass/ceramic, a rubber, a latex and combinations thereof.

22. The method according to claim 19, wherein the applying one or more porous intermediate layers comprises dip coating, flow coating, slip casting, immersion or combinations thereof.

23. The method according to claim 19, wherein the applying the zeolite seed layer comprises dip coating, flow coating, slip casting, immersion or combinations thereof.

24. The method according to claim 19, wherein the provided inorganic porous support is in the form of a honeycomb monolith.

25. The method according to claim 19, wherein the zeolite seed layer is applied from a coating composition that further comprises a dispersant, a binder, an anti-cracking agent, an anti-foam agent or combinations thereof.

26. The method according to claim 19, further comprising heating the inorganic porous support and the one or more porous intermediate layers prior to applying the zeolite seed layer to the one or more porous intermediate layers.

27. The method according to claim 26, wherein the heating the inorganic porous support and the one or more porous intermediate layers comprises sintering the inorganic particles in the one or more intermediate layers.

28. The method according to claim 19, further comprising heating the inorganic porous support, the one or more porous intermediate layers and the zeolite seed layer prior to hydrothermally growing the zeolite intergrown layer from the zeolite seed layer.

29. The method according to claim 19, further comprising heating the inorganic porous support and the applied intermediate and zeolite seed and intergrown layers.

30. The method according to claim 19, wherein the hydrothermally growing a zeolite intergrown layer from the zeolite seed layer step is assisted by microwave energy.
